(19) United States
(12) Patent Application Publication
(10) Pub. No.: US 2015/0283438 A1
(43) Pub. Date: Oct. 8, 2015

(54) DEVICE AND METHOD FOR IMPROVED TENNIS RACKET DAMPING AND WEIGHT ADJUSTMENT

(71) Applicant: HK Innovations, Plano, TX (US)

(72) Inventor: Daniel Hwang, Plano, TX (US)

(21) Appl. No.: 14/542,289

(22) Filed: Nov. 14, 2014

Related U.S. Application Data
(63) Continuation of application No. PCT/US2013/041019, filed on May 14, 2013.
(60) Provisional application No. 61/647,420, filed on May 15, 2012.

(51) Int. Cl. A63B 59/00; B29C 33/38

(52) U.S. Cl. CPC A63B 59/0092; A63B 59/0074; B29C 33/3857; B29L 2031/5245

(57) ABSTRACT

The present application relates to devices and methods for adjusting the weight of a racket using variably weighted racket damping devices.

### CLAIM OF PRIORITY

The present application is a continuation of International Patent Application No. PCT/US2013/041019, filed on May 14, 2013, entitled DEVICE AND METHOD FOR IMPROVED TENNIS RACKET DAMPING AND WEIGHT ADJUSTMENT, which claims benefit to U.S. Provisional Application 61/647,420 filed May 15, 2012, entitled DEVICE AND METHOD FOR IMPROVED TENNIS RACKET DAMPING AND WEIGHT ADJUSTMENT, all of which are hereby incorporated by reference in their entirety.

### BACKGROUND

1. Field

Embodiments disclosed herein relate generally to systems, devices, and methods for damping vibrations and adjusting the weight of a tennis racket.

2. Description of the Related Art

Handheld sports rackets, such as tennis rackets, have a handle and an oval frame extending from the handle. The handle includes a grip by which the player can hold the racket. The racket includes two intersecting sets of parallel strings attached to and suspended from the frame, creating a striking surface or face. One set of strings extends generally parallel to the handle of the racket and may be called the longitudinal strings, while the other set of strings extends generally transversely to the handle and may be called the transverse strings. Vibrations are produced in the racket when a player strikes a ball with the strings of the racket. The vibrations begin at the point of contact between the strings and the ball and the vibrations propagate through the strings to the frame of the racket. When a player strikes the ball with the center of the face of the racket, the vibrations are minimal. The vibrations can be substantial when the ball strikes the strings off of center of the face of the racket or when the ball strikes the frame of the racket. Initially, large vibrations disseminate from the point of contact on the strings, followed by a series of smaller vibrations which eventually die out with time. Such vibrations are transmitted generally along the transverse and longitudinal strings of the racket to the frame, which surrounds and secures the strings in place. The vibration can travel from the frame down to the racket handle and grip and through to the hand and arm of the player. Extensive periods of racket-induced vibrations can cause or exacerbate a “tennis elbow” injury or other such injuries in a player. It is therefore important to reduce such vibrations both for the comfort and protection of the player.

Also important to the comfort, performance, and safety of a tennis player is the use of a correctly weighted tennis racket. Tennis rackets can be purchased in different sizes and weights. A player of a certain skill level may prefer a racket of a certain weight or weight distribution. As a player's skill level changes, his or her preference for the weight of the racket may also change. Furthermore, a player's preference for the weight of the racket may change even during a tennis match as he or she becomes increasingly tired or as the conditions during the match change or even based on the types of strokes the player would like to be hitting. Traditionally, modifying or adjusting the weight of a tennis racquet was difficult, laborious, expensive, and imprecise. Changing the weight of a racket can be particularly difficult during the middle of a tennis match. Traditional methods of racket weight adjustment involve cumbersome devices and prolonged methods of adding weight to either the frame or the handle of the racket. To avoid such difficulties, tennis players often purchase a new, differently weighted racket instead. Purchasing a new racket of a different weight, or carrying multiple rackets of different weights, is an expensive solution to this problem. Other solutions such as placing weights in handle of the racket or applying weighted tape on the frame of the racket have proven cumbersome and imprecise. Applying weight to the handle or the frame of the racket can also have the adverse impact of unintentionally modifying the existing weight distribution in the racket.

Lacking in the prior art are methods, systems, and devices to successfully damp the vibrations in a tennis racket as well as allow for rapid adjustment of the weight of the racket without sacrificing stability, performance, comfort, playability, and safety.

### SUMMARY

The devices, methods, kits and systems described herein have innovative aspects, no single one of which is indispensable or solely responsible for their desirable attributes. Without limiting the scope of the claims, some of the advantageous features will now be summarized.

The present disclosure relates generally to a vibration damping device for use in a racket, having a shell composed of an upper shell and a lower shell and an insert positioned in the shell. The upper and lower shell can each have an interior surface. The vibration damping device can include a gap between the interior surfaces of the upper and lower shells. The gap can form an indentation around at least a portion of the circumference of the vibration damping device.

The vibration damping device can include one or more ridges on the interior surface of at least one of the upper and lower shells. The ridges can form a container on the interior surface in which the insert can be positioned. In some embodiments, both the upper shell and lower shells can each include one or more ridges forming a container on the interior surface of the shell. In certain embodiments, the insert can be positioned in the container on the lower shell. In some embodiments, the container on the upper shell can be larger than the container on the lower shell and can fit around the outside of the container on the lower shell.

Some embodiments of the present disclosure also relate to a kit having a plurality of vibration damping devices. In the kit, the inserts of the vibration damping devices can be approximately the same size. The kit can include vibration damping devices of approximately the same size, but at least two of the vibration damping devices can have different weights.

Some embodiments of the present disclosure also relate to a method of manufacturing a vibration damping device, including forming a negative mold of an upper shell of the vibration damping device and forming a negative mold of a lower shell of the vibration damping device. The method of manufacturing the vibration damping device can also include pouring a liquid rubber into the negative molds of the upper shell and lower shell and allowing the rubber to cure. The method can include removing the rubber upper shell and rubber lower shell from the negative molds and positioning an insert in one of the upper or lower shell and mating the upper shell with the lower shell. In certain embodiments, the insert can be a metal.

Forming the upper shell and lower shell can include forming an interior surface on each of the upper shell and lower shell. The method of manufacturing the vibration damping device can further include forming a container on the interior surface of at least one of the upper shell or lower shell. In certain embodiments, the method can include forming a container on the interior surface of both the upper shell and the lower shell. The container on one of the upper shell or lower shell can be larger than the container on the other shell. In certain embodiments, the limitation of positioning an insert in one of the upper or lower shell can include positioning the insert in the container. The container can be composed of one or more ridges positioned on the interior surface of the upper shell or lower shell. The method of mating the upper shell with the lower shell can include adhering the upper shell to the lower shell.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIG. 1 is top plan view of a tennis racket provided with a non-limiting example of a vibration damping device.

FIG. 2A is a perspective view of a non-limiting example of a vibration damping device according to an embodiment of the disclosure.

FIG. 2B is a perspective view of a non-limiting example of a rubberized shell according to an embodiment of the disclosure.

FIG. 3A is a perspective view of a non-limiting example of a vibration damping device according to an embodiment of the disclosure.

FIG. 3B is a cross-sectional side view of the device taken along line 3B of FIG. 3A.

FIG. 4A is a perspective view of a non-limiting example of two half shells of a shell of the vibration damping device.

FIG. 4B is a partially transparent perspective view of a non-limiting example of a vibration damping device according to an embodiment of the disclosure.

FIG. 4C is a partially transparent top or bottom plan view of a non-limiting example of a vibration damping device according to an embodiment of the disclosure.

FIG. 4D is a partially transparent side plan view of a non-limiting example of a vibration damping device according to an embodiment of the disclosure.

FIG. 5A is a perspective view of a plastic mold of a plurality of vibration damping device according to an embodiment of the disclosure.

FIG. 5B is a perspective view of a manufactured shell with the runners intact according to an embodiment of the disclosure.

### DETAILED DESCRIPTION OF CERTAIN EMBODIMENTS

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

The disclosure provided herein includes devices and methods for quickly and/or accurately modifying the weight of a tennis racket. In some aspects, this can be done without altering the weight distribution of the racket. Also based on the disclosure herein, the weight of the racket can be modified inexpensively compared with existing methods and devices and compared with having to purchase, try out, and carry multiple rackets of varying weight. The disclosure provides these improvements by combining a vibration damping device with a weight adjustment device to make for an inexpensive, easily adjustable, and accurate weight adjustment device in order to maintain stability, performance, comfort, playability, and safety of the player's racket.

Each player of a racket sport has a unique swing pattern and style of play. That said, individual maximum performance during play is often a function of increased power and control of a shot. Power and control, however, can sometimes be competing priorities for a player. Power and control can be dictated by the player's swing velocity, which itself is a function of the racket weight. The disclosed improvements allow a player to easily and accurately adjust the weight of his or her racket in order to optimize the player's swing velocity, thereby improving performance during play.

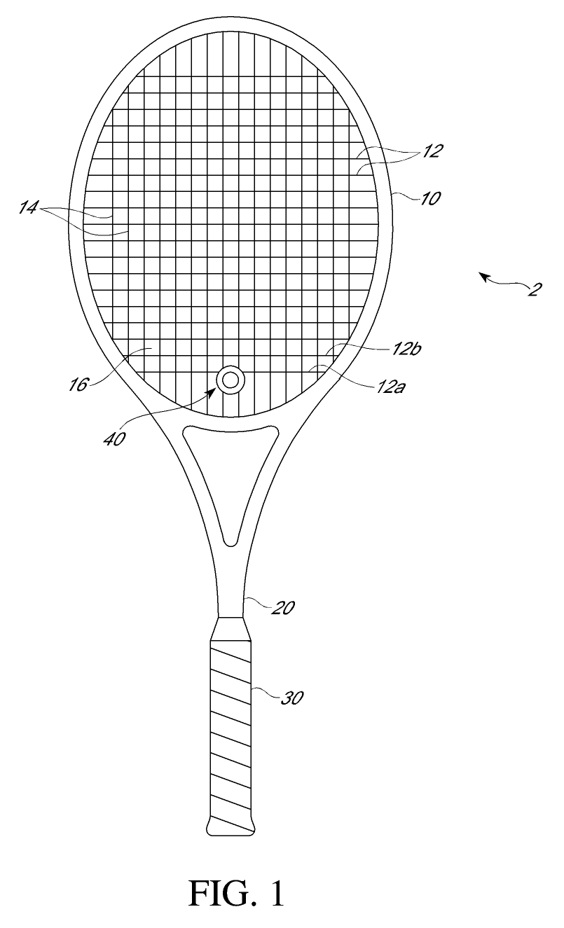

Vibration damping devices can be placed in between, through, or around the strings of a tennis track to reduce the vibration produced by striking of the ball against the strings or frame of the racket. FIG. 1 is top plan view of a tennis racket provided with a vibration damping device. As seen in FIG. 1, a tennis racket 2 can be comprised of a frame 10 with a handle 20 extending from the frame 10. The handle 20 can also include a grip 30 by which the tennis player can hold onto the racket. Attached to the frame are two sets of strings that run perpendicular to one another other. One set of strings, the transverse strings 12, run in a direction transverse to a longitudinal axis and handle of the racket 2. Perpendicular to the transverse strings 12 are the longitudinal strings 14 which run in the direction parallel with the longitudinal axis and handle of the racket 2. As shown in FIG. 1, a vibration damping device 40 can be placed in the strings of the racket 2, to be positioned between two longitudinal strings 14 and either below the bottommost transverse string 12a or alternatively positioned between two transverse strings 12, such as between transverse strings 12a and 12b.

The vibration damping device 40 shown in FIG. 1 is approximately spherical in shape. Other shapes and sizes of vibration damping devices are contemplated and within the scope of the present disclosure. For example, the vibration damping device 40 may also be square, oval, rectangular or cubic in shape. The vibration damping device 40 may be, for example, a round cylinder, an oval cylinder, a sphere, a cube, a non square or cubic polyhedron, or a shape corresponding to a specific brand's logo. As a further example, the device 40 may be, alternatively, a longer, thinner device such that when the device is inserted into the racket 2 it can run in a transverse direction and can be, for example, weaved or laced in and out of multiple longitudinal strings 14 at the bottom of the racket face 16. The vibration damping device 40 of the present disclosure can be provided with branding or sponsorship information, for example to match the brand of the player's tennis racket. Additionally, the vibration damping device 40 can be void of such branding. The device can include one or more indicators of the weight of the device, for example numerical, color, letter or other indicators.

An embodiment of the vibration damping device 40, regardless of the shape of the device 40, can include an indentation or channel circumventing the exterior of the vibration damping device 40. The indentation provides a structure to position the device between the longitudinal strings 14 and transverse strings 12. The indentation can be approximately the width of racket string and may be deep enough such that when the device 40 is placed into the racket strings the device 40 fits securely within the strings and does not easily become dislodged. In some embodiments, the width of the indentation also can be such that the strings fit tightly or securely within the indentation.

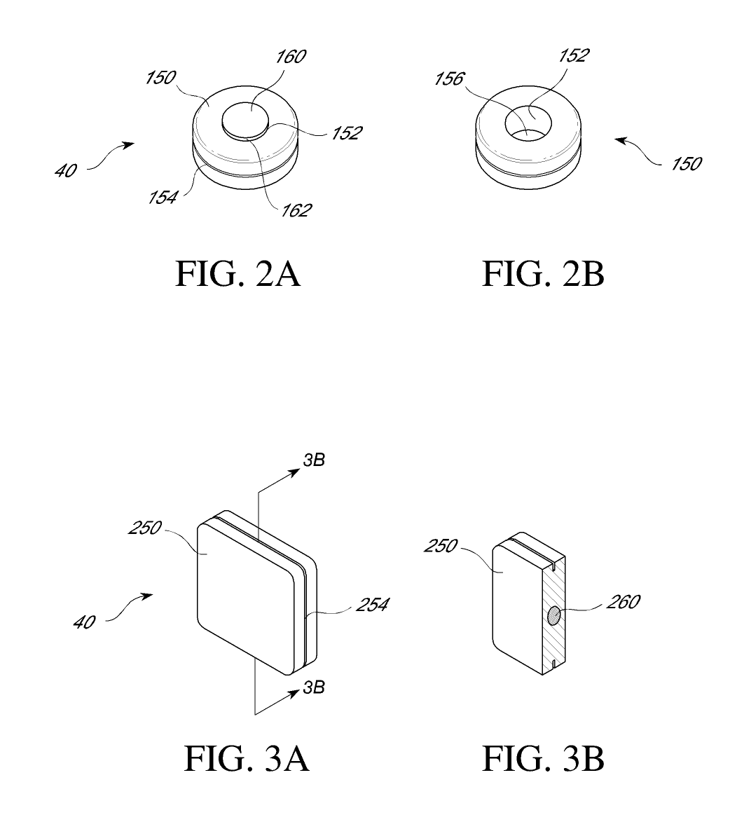

The disclosure herein provides methods and devices for adjusting the weight of a racket by adjusting the weight of the vibration damping device 40. FIG. 2A is a perspective view of a vibration damping device 40 according to an embodiment of the disclosure. The non-limiting example of a vibration damping device 40 in FIG. 2A is comprised of a rubberized shell 150 and an insert 160. The rubberized shell 150 can include an annular channel or indentation 154 at least partially circumventing the exterior of the rubberized shell 150. The annular indentation 154 may also fully circumvent the exterior of the rubberized shell 150. The rubberized shell 150 can be composed of one or more natural or synthetic rubberized polymers. While a “rubberized” shell is described herein, it should be understood that other damping materials can be utilized for the shell, such as, for example, various types of foam, elastomeric polymers, thermoplastic polymers, ceramic material, and other natural or synthetic materials, or any combination thereof. Damping materials can absorb and reduce the vibrational energy created when a ball strikes the racket 2.

The insert 160 may be composed of, for example, certain metals, alloys, foam, elastomeric polymers, thermoplastic polymers, ceramic material, and other natural or synthetic materials, or any combination thereof.

To implement the vibration damping device 40 shown in FIGS. 2A and 2B, one can place the rubberized shell 150 into the strings of the racket 2 between two longitudinal strings 14 and either below the bottom most transverse string 12 or between two transverse strings 12. Once in place, the rubberized shell 150 can be fitted with an insert 160 of a weight desired by the player.

FIG. 2B shows the rubberized shell 150 without the insert 160. Shown in FIG. 2B is an aperture or annular bore 156 running through the center of the rubberized shell 150, defined by an interior wall 152 of the rubberized shell 150. An insert 160 of a desired weight can be placed into the annular bore 156 in the rubberized shell 150. The insert 160 can have an exterior wall 162 that fits securely against the interior wall 152 of the rubberized shell 150. The 160 insert can have a mechanism for securing it removably or permanently to the rubberized shell 150. For example, the mechanism can be, or can include, one or more of a ridge, indentation, fastener, knob, or joint. It should be understood that FIG. 2B depicts one non-limiting example of a device with a removable weight or insert. Other configurations that utilize, for example, a rubberized (or other damping material, for example) shell or portion that contacts the racket strings, as well as one or more weighted inserts can be utilized in a vibration damping device 40. For example, the insert 160 can be removably or permanently attached to an outside portion of the rubberized shell 150.

In order to adjust the weight of the vibration damping device 40, and thus adjust the weight of the racket 2, a player can remove the insert 160 already in the rubberized shell 150 and replace it with an insert 160 of the different weight. The weight of different inserts 160 can be varied by maintaining the size of the insert 160 and using different material compositions with different densities for the insert. The weight of the insert 160 can also be varied by maintaining the material composition and varying the size of the insert 160. Furthermore, the weight of the insert can be varied by varying both the size of the insert 160 and the material composition.

If the weight of the inserts is varied by varying by the size of the inserts 160, a lighter weight insert 160 may be small enough to be set inside the annular aperture or bore 156, thus set below the top and bottom surfaces of the rubberized shell. A heavier insert 160 may be longer than a lighter weight insert 160 and thus may be set flush with the top and/or bottom surfaces of the rubberized shell 150 or may even extend beyond the top and/or bottom surfaces of the rubberized shell 150. In some instances the insert 160 may have a top and/or bottom that is below the top and/or bottom of the rubberized shell 150.

The ease with which an insert 160 can be replaced with a different insert provides a way for the player to easily adjust the weight of the racket. The player can know precisely how much weight is being added to the racket by knowing the precise weight of the inserted to be placed in the rubberized shell 150. Thus, changing the weight of the racket can be performed rapidly, easily, and precisely.

Multiple inserts 160, either of the same weight or each with a different but precisely measured weight can be packaged and sold together as a kit, along with or separate from the rubberized shell 150. Such a kit can allow a tennis player to adjust the weight of his or her racket as needed, according to his or her changing ability or changing conditions during or between tennis matches.

The weight of the insert 160 can be produced and used in weights varying from 0.5 g to 50 g. For example, an individual insert may weigh from about 0.5 g to about 100 g, for example, or any value there between. In some aspects an individual insert may weigh, for example, 0.5 g, 1 g, 2 g, 3 g, 4 g, 5 g, 6 g, 7 g, 8 g, 9 g, 10 g, 11 g, 12 g, 13 g, 14 g, 15 g, 16 g, 17 g, 18 g, 19 g, 20 g, 21 g, 22 g, 23 g, 24 g, 25 g, 26 g, 27 g, 28 g, 29 g, 30 g, 31 g, 32 g, 33 g, 34 g, 35 g, 36 g, 37 g, 38 g, 39 g, 40 g, 41 g, 42 g, 43 g, 44 g, 45 g, 46 g, 47 g, 48 g, 49 g, or 50 g. The inserts can be labeled or coded using numbers, letters, words, colors or other indicators of their weight and/or size, for example. Kits may include any combination of differently weighted inserts 160.

An embodiment of the vibration damping device 40 is shown in FIGS. 3A and 3B. FIG. 3A is a perspective view of a vibration damping device according to an embodiment of the disclosure. The vibration damping device 40 can include a rubberized shell 250 and an indentation 254 circumventing all or part of the exterior of the rubber shell 250. The indentation 254 provides one non-limiting example of the structure by which to position the device between the longitudinal strings 14 and transverse strings 12. The indentation 254 can be approximately the width of a racket string and may be deep enough such that when the device 40 is placed into the racket strings the device 40 fits securely within the strings and does not easily become dislodged. In some embodiments, the width of the indentation 254 also can be such that the strings fit tightly or securely within the indentation.

FIG. 3B is a cross-sectional side view of the device taken along line 3B of FIG. 3A. Shown in FIG. 3B is the rubberized shell 250 of the vibration damping device 40. Also shown in FIG. 3B is a core 260. The core 260 can be made of certain metals, alloys, polymers, or any combination thereof. The core 260 can be encased partially or entirely in an aperture or gap in the rubberized shell 250. The core 260 can be made to be a precise weight, such that when combined or encased in the rubberized shell, the total weight of the vibration damping device 40 of FIGS. 3A and 3B is of a known, precise weight.

To obtain vibration damping devices 40 of varying weights, the weight of the core 260 can be varied. For example, materials of different densities can be used for the core 260 to obtain a vibration damping device of a different weight, or the size of the core 260 can increased or decreased to vary the weight of the vibration damping device 40, or the type of material used as the core 260 can be varied to vary the weight of the vibration damping device 40. A vibration damping device 40 of a specific weight can be sold individually. Alternatively, multiple vibration damping devices 40, either of the same weight or each with a different but precisely measured weight can be packaged and sold together as a kit. It should be understood that any shape of shell 250 and/or core 260 can be utilized, not just the shapes and configuration depicted.

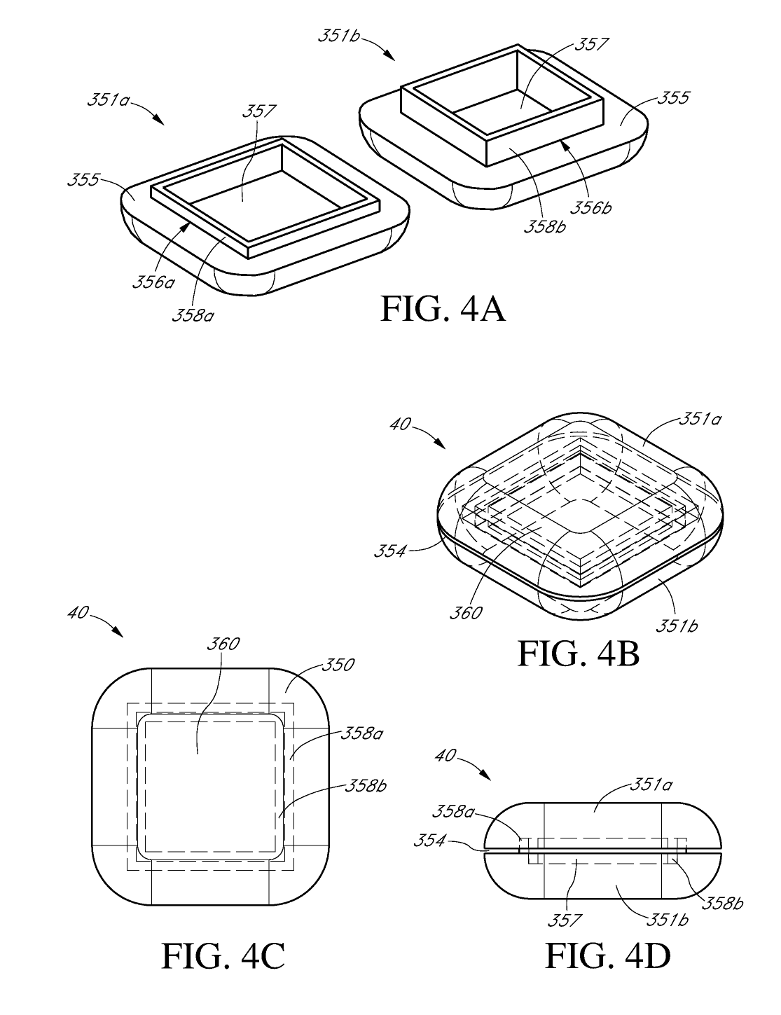

FIGS. 4A-4D depict another embodiment of a vibration damping device 40. FIG. 4A shows the upper shell 351a and the lower shell 351b that together form the shell 350 of the vibration damping device 40. The upper shell 351a and lower shell 351b can have an interior surface 355. The interior surface 355 can be a planar surface or may contain different ridges or recesses to form cavities thereon as described below.

In one embodiment, the interior surface 355 of each half of the shell 350 may contain one or more ridges 358a, 358b extending from the interior surface 355. The ridges 358 on each interior surface 355 can form a container 356. The container 356 can provide an inner cavity 357 on the interior surface 355 of each of the upper shell 351a and lower shell 351b. The container 356 can act as a receptacle for receiving and housing a core or insert 360 in the vibration damping device 40. The insert 360 can be placed in the container 356 to be in contact with the ridges 358 on the sides and the inner cavity 357 on the bottom or top. In the embodiment shown in FIG. 4A, the ridges 358a, 358b on each interior surface 355 form a square shape to form the container 356. It will be appreciated by one of skill in the art that other shapes are contemplated, and the shape of the ridges 358 in the shell 350 can be manufactured to correspond to the shape of the insert 360 added to the vibration damping device 40.

In some embodiments, the interior surface 355 of the shell 351 can be recessed in the inner cavity 357 such that inside of the container 356 is deeper than the portion of the interior surface 355 exterior to the container 356. As shown in FIG. 4A, the lower shell 351b can include a container 356b having ridges 358b with a larger relative height extending from the interior surface 355 of the shell than the ridges 358a of the container 356a on the upper shell 351a. Also as shown in FIG. 4A, the container 356a on the upper shell 351a can be wider and longer than container 356b on the lower shell 351b. In this manner, the container 356a on the upper shell 351a can fit around the circumference of the container 356b on the lower shell 351b when the two halves of the shell 350 are mated. In one embodiment, the upper and lower containers 356a, 356b are sized such that the upper container 356a acts as a cap to the lower container 356b. The inside of the ridges 358a of the upper container 356a may contact the outside of the ridges 358b of the lower container 356b. In one embodiment when the two half shells 351a, 351b are mated, the top of the ridges 358a of the upper shell 351a can contact the interior surface 355 of the lower shell 351b at a location outside of the ridges 358b of the container 356b. The relative heights of the containers 356a, 356b can be established such that when the two half shells 351a, 351b are mated, a gap can be maintained between the interior surfaces 355 of the upper and lower shells 351a, 351b at a location exterior to the containers 356 in order to form the indentation 354 circumventing the exterior of the shell 350. Furthermore, the containers 356a, 356b and the insert 360 can be sized such that when the half shells 351a, 351b are mated after having an insert 360 positioned in the inner cavity 357 of the containers 356a, 356b, the insert can be in contact with, and secured by, the ridges 358b of the lower container 356b on the sides and in contact with, and secured by, the interior surfaces 355 of the inner cavity 357 of the top and bottom of the containers 356a, 356b.

In some embodiments, only one side of the shell 350 (for example, the lower shell 351b) may include the ridges 358b to form a container 356b and provide an inner cavity 357 for housing the core or insert 360. In this embodiment, the upper shell 351a may have a substantially planar interior surface 355 on which the ridges 358b can rest when the upper and lower shells 351a, 351b are mated. In some embodiments, the interior surface 355 of the upper shell 351a may include an indentation in which the ridges 358b of the lower container 356b may be placed.

FIGS. 4B-4D show partially transparent views of the vibration damping device 40 after the upper and lower shells 351a, 351b have been mated following manufacture and assembly. FIGS. 4B and 4C show the vibration device 40 after insertion of the insert 360 in the inner cavity 357. FIG. 4B is a partially transparent isometric view of the assembled vibration damping device 40; FIG. 4C is a partially transparent top plan view of the assembled vibration damping device 40; and FIG. 4D is a partially transparent side plan view of the assembled vibration damping device 40. Shown in the FIGS. 4B-4D are the upper and lower shells 351a, 351b of the shell 350, the indentation 354, the insert 360, the upper and lower ridges 358a, 358b, and the inner cavity 357.

The vibration damping devices 40 disclosed herein can be manufactured in a variety of ways. For example, the vibration damping devices 40 can be manufactured by injection molding, extrusion, 3D printing. In one method of manufacturing the vibration device 40, the shell can be manufactured of a composite rubber, mixing different types of rubbers and compositions to obtain the variable weights of the vibration damping devices 40. The composite used in the vibration damping device 40 can include a mixture of rubber and metal and/or an alloy. A variable weighted composite rubber can be used instead of using an insert or core to vary the weight of the vibration damping device 40, or alternatively, a variably weighted composite rubber can be used in conjunction with an insert or core.

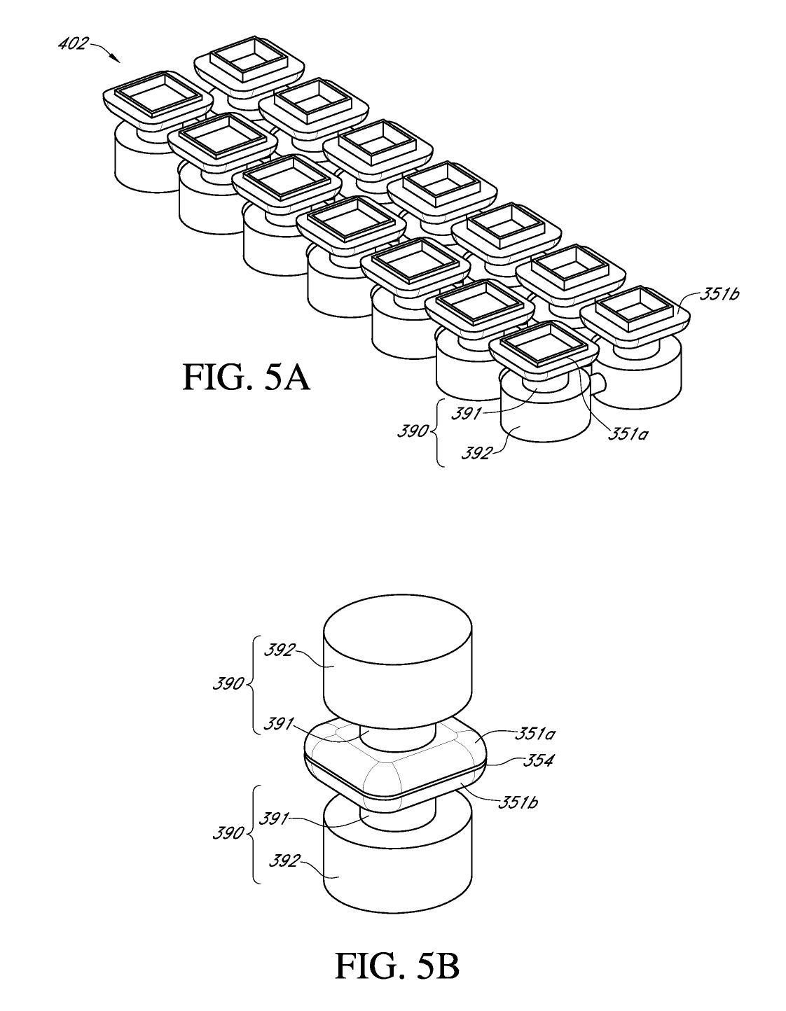

One method of manufacturing the shell 351a, 351b of vibration damping device disclosed in FIGS. 4A-D is described herein and depicted in part in FIGS. 5A and 5B. A three-dimensional plastic mold 402 of one or more sets of the shells 351a, 351b of the vibration damping device 40 can be made. As shown in FIG. 5A, the plastic mold can include a runner 390 comprised of an extension 391 and a base 392. The plastic mold 402 can include one or more of the upper halves 351a of the shell 350 attached to an extension 391 of the runner 390 on one side of the mold 402 and can include a corresponding number of lower halves 351b of the shell 350 attached to an extension 391 of the runner 390 on the other side of the mold 402. The plastic mold 402 can be substantially the same dimensions and shape as the desired end product shell 350.

Following the manufacture of the plastic mold, a negative master mold of the shells 350 can be constructed using the plastic mold 402. In one embodiment, a silicone polymer, such as for example, polydimethylsiloxane (PDMS) can be used to form the negative mold. The plastic mold 402 of the shell 350 can be placed in a suitable container and the silicone polymer can be poured as a liquid into a container over the plastic mold 402. The silicone polymer can cure at room temperature or at an elevated temperature for a suitable duration. After curing, the plastic mold 402 can be removed from the cured silicone polymer to produce a silicone negative mold of the shells 350 as attached to the runners 390.

Into the negative mold, a liquid rubber resin can be poured to fill the cavities in the negative mold to form the shells attached to runners 390. The rubber can be a natural or synthetic rubber, for example, a silicone rubber. The rubber can be allowed to cure in the negative mold at room temperature or at an elevated temperature for a suitable duration. Curing times can vary and range from 8-24 hours. After the rubber has cured in the negative mold, the formed shells 350 can be removed from the mold with the runners attached 390 and separated from one another. As shown in FIG. 5B, in one embodiment, the runners 390 are maintained on the shell halves 351a, 351b until the shell halves have been mated. The runners can then be removed and the outer surfaces of the shell halves can smoothed.

An insert 360 can be inserted into the container 356 of one half of the shell 350 (for example, in the container 356b of the lower shell 351b). The other half of the shell 350 (for example, the upper shell 351b), can be positioned over the half shell with the insert 360 positioned inside. In one embodiment, the upper and lower shells 351a, 351b can be mated and sealed together using glue or other adhesives. Different weighted inserts 360 can be added to different vibration damping devices 40 to provide the user with the option of using differently weighted vibration damping devices 40. The vibration damping devices 40 can be sold individually at a certain weight or can be sold as a group in a kit with varying weighted vibration damping devices 40 in the kit. For example, one vibration damping device 40 may be provided without an insert 360 in the inner cavity 357 to provide the lightest weight vibration damping device 40 in a group.

In one embodiment, the half shells 351a, 351b may not be sealed following manufacture, but instead can be manufactured to fit securing together based on the mating of the upper container 356a over the lower container 356b. In this manner, a user of the vibration damping device 40 can open the half shells 351a, 351b to replace the insert 360 with a differently weighted insert 360 to adjust the weight of the vibration damping device 40.

In some embodiments, the shell 350 can be made of a rubber and can weigh approximately at least about 0.5 g; at least about 1.0 g; at least about 1.5 g; at least about 2.0 g; at least about 2.5 g; at least about 3 g; at least about 3.5 g; at least about 4.0 g; at least about 4.5 g; at least about 5.0 g; at least about 5.5 g; at least about 6.0 g; at least about 6.5 g; at least about 7.0 g; at least about 7.5 g; or at least about 8.0 g.

In some embodiments, the shell 350 can weigh no more than about 8.0 g; no more than about 7.5 g; no more than about 7.0 g; no more than about 6.5 g; no more than about 6.0 g; no more than about 5.5 g; no more than about 5.0 g; no more than about 4.5 g; no more than about 4.0 g; no more than about 3.5 g; no more than about 3.0 g; no more than about 2.5 g; no more than about 2.0 g; no more than about 1.5 g; no more than about 1.0 g; or no more than about 0.5 g.

The weight of the insert 360 used in the shell 350 can be varied. For example, an individual insert 360 may weigh from about 0.5 g to about 100 g, for example, or any value there between. In some aspects an individual insert 360 may weigh, for example, 0.5 g, 1 g, 2 g, 3 g, 4 g, 5 g, 6 g, 7 g, 8 g, 9 g, 10 g, 11 g, 12 g, 13 g, 14 g, 15 g, 16 g, 17 g, 18 g, 19 g, 20 g, 21 g, 22 g, 23 g, 24 g, 25 g, 26 g, 27 g, 28 g, 29 g, 30 g, 31 g, 32 g, 33 g, 34 g, 35 g, 36 g, 37 g, 38 g, 39 g, 40 g, 41 g, 42 g, 43 g, 44 g, 45 g, 46 g, 47 g, 48 g, 49 g, or 50 g. To varying the weight of the inserts 360, they may be manufactured of different materials. For example, an insert 360 can be manufactured from aluminum, tin, lead, or a combination of these materials. By modifying the material of manufacture for a given insert 360, the size of the insert can be maintained among the differently weighted inserts 360, but the weight can be varied. This is because the different materials have different densities. For example, the density of lead is greater than the density of tin and the density of tin is greater than the density of aluminum.

The vibration damping devices 40 disclosed herein can be produced and used with a total weight varying from 0.5 g to 50 g. For example, an individual vibration damping device 40 may weigh from about 0.5 g to about 100 g or any value therebetween. 0.5 g, 1 g, 2 g, 3 g, 4 g, 5 g, 6 g, 7 g, 8 g, 9 g, 10 g, 11 g, 12 g, 13 g, 14 g, 15 g, 16 g, 17 g, 18 g, 19 g, 20 g, 21 g, 22 g, 23 g, 24 g, 25 g, 26 g, 27 g, 28 g, 29 g, 30 g, 31 g, 32 g, 33 g, 34 g, 35 g, 36 g, 37 g, 38 g, 39 g, 40 g, 41 g, 42 g, 43 g, 44 g, 45 g, 46 g, 47 g, 48 g, 49 g, or 50 g. Kits may include any combination of differently weighted vibration damping devices. The vibration damping device 40 can be labeled or coded using numbers, letters, words, colors or other indicators of their weight and/or size, for example.

The devices described above and depicted in the figures show the use of a single damping and/or weighting device being used with a racket. It should be understood that in some embodiments, multiple damping and/or weighting devices as described herein can be utilized. Also, FIGS. 2A, 2B, 3A, 3B, 4B, and 4C depict a shell with a single insert or core. Nonetheless, it should be understood that in some embodiments a shell can receive more than one insert or core, or can include receiving spaces (e.g., the annular bore 156 of FIG. 2B) for more than one insert or core, even if only one insert or core is used at times. The receiving space can be “capped” or “plugged” with a cover or plug that does not provide substantial weight to the device. Furthermore, in some embodiments the shell can be configured so that one or more inserts or cores is inserted or attached to the shell from a different approach or direction. For example, rather than attach the insert or core through the center of the shell perpendicular to the face 16 or plane of the racket 2, the insert or core can be inserted more or less parallel to the longitudinal strings (e.g., strings 14 of FIG. 1) into the bottom end or portion of the shell that when in place is closest to the handle. The insert or core can be placed or secured via any other suitable direction or orientation as well.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof. The terms “upper” and “lower” or “top” and “bottom” are used herein as relative terms to indicate separate structural entities and are not intended to impart rigid spatial orientations to the associated components. For example, whether a component is an “upper” component or a “lower” component may change based on the perspective at which the component is viewed.

It will be appreciated by those skilled in the art that various modifications and changes may be made without departing from the scope of the described technology. Such modifications and changes are intended to fall within the scope of the embodiments, as defined by the appended claims. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged, or excluded from other embodiments.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A vibration damping device for use in a racket, comprising:
a shell comprising an upper shell and a lower shell mated together; and
an insert positioned in the shell.

2. The vibration damping device of claim 1, wherein the upper and lower shell each comprise an interior surface.

3. The vibration damping device of claim 2 comprising a gap between the interior surfaces between the upper and lower shells, the gap forming an indentation around at least a portion of the circumference of the vibration damping device.

4. The vibration damping device of claim 2, wherein at least one of the upper and lower shells comprises one or more ridges on the interior surface.

5. The vibration damping device of claim 4, wherein the ridges form a container on the interior surface in which the insert is positioned.

6. The vibration damping device of claim 4, wherein both the upper shell and lower shells each comprise one or more ridges forming a container on the interior surface of the shell.

7. The vibration damping device of claim 6, wherein the insert is positioned in the container on the lower shell.

8. The vibration damping device of claim 7, wherein the container on the upper shell is larger than the container on the lower shell and fits around the outside of the container on the lower shell.

9. A kit comprising a plurality of the vibration damping devices of claim 1.

10. The kit of claim 9, wherein the inserts of the vibration damping devices are approximately the same size.

11. The kit of claim 9, wherein at least two of the vibration damping devices have different weights.

12. A method of manufacturing a vibration damping device, the method comprising:
forming a negative mold of an upper shell of the vibration damping device;
forming a negative mold of a lower shell of the vibration damping device;
pouring a liquid rubber into the negative molds of the upper shell and lower shell and allowing the rubber to cure;
removing the rubber upper shell and rubber lower shell from the negative molds;
positioning an insert in one of the upper or lower shell; and
mating the upper shell with the lower shell.

13. The method of claim 12, wherein the insert comprises a metal.

14. The method of claim 12, wherein forming the upper shell and lower shell further comprises forming an interior surface on each of the upper shell and lower shell.

15. The method of claim 14, further comprising forming a container on the interior surface of at least one of the upper shell or lower shell.

16. The method of claim 15, comprising forming a container on the interior surface of both the upper shell and the lower shell.

17. The method of claim 16, wherein the container on one of the upper shell or lower shell is larger than the container on the other shell.

18. The method of claim 15, wherein positioning an insert in one of the upper or lower shell further comprises positioning the insert in the container.

19. The method of claim 15, wherein the container comprises one or more ridges positioned on the interior surface.

20. The method of claim 12, wherein mating the upper shell with the lower shell further comprises adhering the upper shell to the lower shell.
